(19) United States
(12) Patent Application Publication
(10) Pub. No.: US 2011/0014481 A1
(43) Pub. Date: Jan. 20, 2011

(54) Low Absorption Spectral Selective Solar Control Film for Fenestration

(76) Inventors: Stephen S. Wilson, Las Vegas, NV (US); Bart Wilson, Las Vegas, NV (US); Seth Wilson, Las Vegas, NV (US)

Correspondence Address: STETINA BRUNDA GARRED & BRUCKER, 75 ENTERPRISE, SUITE 250, ALISO VIEJO, CA, 92656, US

(21) Appl. No.: 12/502,878

(22) Filed: Jul. 14, 2009

(51) Int. Cl. B32B 17/06; E04F 13/00

(52) U.S. Cl. 428/426; 156/71

(57) ABSTRACT

A building structure having a high efficiency solar control system is provided. The building structure may have a window defined by a sheet of glass and a film mounted to its exterior side. The film may reflect solar radiation in the near and mid infrared ranges yet allow high transmission of light in the visible range such that the occupants of the building structure may view his/her surroundings through the window. The film may have a layer of silver which reflects the solar radiation in the near and mid infrared ranges. Since the silver is susceptible to oxidation and turns the silver into a black body which absorbs the near and mid infrared radiation, the film may be designed to slow the rate of oxidation of the silver layer to an acceptable level. The silver layer may be sandwiched between the glass which does not allow oxygen to diffuse there through and reach the layer of silver and a stack of sacrificial layers having a certain thickness which slows down the rate of oxygen diffusion to an acceptable level.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a building structure having a film mounted to its window for reducing solar radiation load.

In warm and humid climates, direct sunlight on the building structure may cause its occupants to use the air conditioning system and/or use the air conditioning system at a higher level. Unfortunately, the air conditioning system may waste a large percentage of energy due to solar gain. By way of example and not limitation, it is believed that about 5% of the entire energy consumption in the United States is related to unwanted heat gain or loss through residential windows. High efficiency window systems have been developed such as triple or quadruple glazing window systems. Unfortunately, these systems add significant weight and cost to the window system. As a result, they have not received widespread adoption. In support thereof, these systems are believed to account for less than one percent of today's window sales. Additionally, the labor and material costs to retrofit existing homes with these high efficiency windows is believed to be excessively high (e.g., over $30,000 per home) in comparison to its energy efficiency benefits.

Several factors determine the comfort level within the building structure. They include the air temperature, air speed within the building structure, humidity of the air within the building structure and the amount of thermal radiation entering the building structure such as through the window. When the air temperature is uncomfortably hot, the occupants may turn on the air conditioning system to cool down the average air temperature. In this instance, the air conditioning unit consumes energy to reduce the air temperature within the building structure. The occupants may also turn on and/or increase fan speed to increase air speed of the air circulating within the building structure. The fan consumes energy. The speed of air within the building structure increases evaporation of moisture on the skin of the occupants which cools the occupant's skin temperature.

During the day, the building structure is exposed to solar radiation. A portion of the solar radiation is absorbed by the window and heated. For example, a large portion of the near infrared radiation and all of the mid infrared radiation are absorbed by the window and re-radiated into the interior of the building structure. The heated window re-radiates heat into the building structure to thereby increase the interior of the building structure's air temperature and heats up the interior of the building structure. A portion of the solar radiation is transmitted through the window and absorbed by the interior of the building structure (e.g., appliances, sofas, furniture, etc.). Upon absorption, the interior of the building structure re-radiates the absorbed energy into the air within the building structure. This further increases the air temperature within the building structure. The hot air and the hot interior of the building structure re-radiates energy generally as infrared radiation in the mid infrared range. Unfortunately, glass windows generally do not allow the mid infrared radiation to pass therethrough. As such, the mid infrared radiation is retained within the building structure and increases a temperature of the building structure above ambient temperature.

A portion of the solar radiation transmitted through the window may also be absorbed by the occupant's skin. This portion of the sun's rays may cause the occupants to feel uncomfortably hot thereby encouraging use of the air conditioning system even if the air temperature is within a comfortable range. This may cause the occupant to turn on the air conditioning system and/or fan. Use of the air conditioning system and the fan both consume energy. Any reduction in the use of the air conditioning system and fan would also reduce the total amount of consumed energy.

The human skin contains receptors that are sensitive to thermal radiation in the infrared range. When the occupants of the building structure are exposed to infrared radiation, the occupants may be uncomfortable even if the air temperature within the building structure is within a comfortable range. The occupants may resort to decreasing the average air temperature within the building structure and increasing the air speed of the fan system to counteract the discomfort caused by thermal radiation, both of which consume increasing amounts of energy.

Conversely, during the winter months, heat is lost through the windows of the building structure. In particular, objects within the building structure are heated by the heating system, fireplace, body heat, etc. The heated objects emit infrared radiation in all directions including toward the window of the building structure. This infrared radiation may be transmitted through the window of the building structure thereby increasing the heating needs of the building structure.

As such, there is a need in the art for an apparatus and method for reducing the need to use the air conditioning system and/or fan of the building structure's cooling system and reducing occupant exposure to solar infrared radiation. Additionally, there is a need in the art for an apparatus and method for retaining infrared radiation within the building structure to retain heat and reduce the load on the building structures heating system due to loss of infrared radiation.

### BRIEF SUMMARY

The present invention addresses the needs discussed above, discussed below and those that are known in the art.

A building structure is provided having a high efficiency solar control system. The solar control system may comprise a glass sheet and a film mounted to its exterior side, namely, the side closer to the environment. The glass and film may define a window (e.g., bedroom window, backdoor window, etc.) of the building structure. The film may have high transmission of light in the visible range such that the occupants of the building structure may view his/her surroundings through the window. Also, the film may reflect a high percentage of light in the near infrared range and the mid infrared range back into the environment. As such, during the summer months, the solar load on the building structure is reduced by the amount of solar radiation in the near infrared range and the mid infrared range reflected back into the environment.

Conversely, during the winter months, the film may be operative to reflect thermal radiation emanating from within the building structure back into the building structure to retain heat within the building structure and reduce a load on the building structure's heating system. As previously discussed, the heated objects within the building structure and the occupants emanate thermal radiation in all directions. This thermal radiation includes infrared radiation in the near, mid and far infrared ranges. This thermal radiation may be directed toward the windows of the building structure. A portion of the thermal radiation is absorbed by the glass of the window and re-radiated back into the interior of the building structure. A portion of the thermal radiation may be absorbed by the glass and re-radiated toward the film. Fortunately, the film reflects substantially all of the reradiated thermal radiation in the mid and far infrared ranges and about half in the near infrared range back to the glass which absorbs the reflected thermal radiation and re-radiates the thermal radiation back into the interior of the building structure.

The film may additionally have a plurality of sacrificial layers which have a high transmission value with respect to the visible range and the near and mid infrared ranges. The topmost sacrificial layer may be removed or peeled away when it has been unacceptably degraded due to environmental elements (e.g., chips, oxidation, etc.) thereby exposing a fresh new topmost layer. Additionally, the additional sacrificial layers mitigate oxidation of a silver layer embedded within the film. In particular, the film is mounted to glass of the window. As such, one side of the film does not allow diffusion of oxygen into the film since oxygen cannot diffuse through the glass. On the other side of the film (or the silver layer(s)), a thick stack of sacrificial layers may be formed. Although oxygen may be diffused through the sacrificial layers, such diffusion of oxygen through the sacrificial layers may be slowed down by increasing the thickness of the sacrificial layers. Either or both the number of sacrificial layers may be increased or decreased as appropriate or the thickness of each of the sacrificial layers may be increased or decreased to bring the rate of oxygen diffusion to an acceptable level. The silver layer is disposed between the glass and the thick stack of sacrificial layers which protects the silver layer from oxidation.

More particularly, a building structure for protecting people from an environment is disclosed. The building structure may comprise a glass window defining an interior side and an exterior side and a film attached to the exterior side of the glass window for reflecting solar infrared radiation away from the glass window to the environment and reflecting thermal radiation back into the building structure. The film may comprise an infrared reflecting layer and one or more protective layers. The infrared reflecting layer may define an interior side and an exterior side. The interior side of the infrared reflecting layer may be attached to the exterior side of the glass window. The infrared reflecting layer may have an embedded infrared reflecting core which comprises one or more layers of silver and one or more layers of dielectric for reflecting infrared radiation. The silver and dielectric layers may alternate. The one or more protective layers may be removeably attached to the exterior side of the infrared reflecting layer for mitigating oxidation of the silver layer and for providing a sacrificial top layer which can be removed when damaged due to ultraviolet light exposure or oxidation.

An adhesive layer may be disposed between the infrared reflecting layer and the glass window for adhering the film to the glass window. The infrared reflecting layer may be generally transparent to visible spectrum of light. The infrared reflecting layer may be fabricated from biaxially-oriented polyethelene terephthalate. The protective layers may be peelably adhered to one another. An exterior side of each of the protective layers may have an ultraviolet light absorbing hard coat. The adhesive may be an ultraviolet light absorbing adhesive. The one or more protective layers may be sufficiently thick to reduce the rate of oxidation of the silver layer to a level such that the film has a sufficiently useful long life. The one or more protective layers may be fabricated from biaxially-oriented polyethelene terephthalate.

A method for reducing solar radiation load on a building structure or reducing a heating requirement is also disclosed. The method may comprise the steps of providing and attaching. The providing step comprises the step of providing a film for reflecting infrared radiation to an exterior of the building structure for reducing the solar radiation load or to an interior of the building structure to retain heat therewithin. The film comprises an infrared reflecting layer defining an interior side and an exterior side. The infrared reflecting layer may have an embedded infrared reflecting core which comprises one or more layers of silver and one or more layers of dielectric for reflecting infrared radiation. One or more protective layers may be removeably attached to the exterior side of the infrared reflecting layer for mitigating oxidation of the silver layer and for providing a sacrificial top layer which can be removed when damaged due to ultraviolet light exposure or oxidation. The attaching step comprises the step of attaching an interior side of the infrared reflecting layer to an exterior side of a glass window of the building structure.

The attaching step may comprise the step of adhering the interior side of the infrared reflecting layer to the exterior side of the glass window.

The method may further comprise the step of providing a stack of sacrificial layers removeably attached to each other such that a top most sacrificial layer may be removed and discarded when the top most protective layer is damaged due to ultraviolet light exposure or oxidation. The sacrificial layers may each be a layer of biaxially-oriented polyethelene terephthalate or similar material. The method may further comprise the step of mounting the stack of sacrificial layers to the one or more protective layers.

A building structure is disclosed. The building structure may comprise a glass window defining an interior side and an exterior side and a film attached to the exterior side of the glass window for reflecting infrared radiation away from the glass window. The film may comprise an infrared reflecting core which comprises one or more layers of silver and one or more layers of dielectric for reflecting infrared radiation. The infrared reflecting core may define opposed first and second sides. The film may also comprise a first protective layers attached to the first side of the infrared reflecting layer. The first protective layer having a first thickness. The film may also comprise a second protective layer attached to the second side of the infrared reflecting layer and the glass window. The second protective layer having a second thickness. The first thickness being greater than the second thickness. The first and second protective layers provide structural support to the one or more silver layers. Also, the thicker first protective layer mitigates oxidation of the one or more silver layers caused by oxygen diffusion through the first protective layer. In the building structure, a stack of sacrificial layers may be mounted to the thicker first layer. The stack of sacrificial layers may be removeably attached to each other such that a top most sacrificial layer may be removed and discarded when the top most sacrificial layer is damaged due to ultraviolet light exposure or oxidation. The sacrificial layers may be adhered to each other. The first thickness is sufficiently thick to reduce the rate of oxidation of the silver layer to a level such that the film has a sufficiently long useful life.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a building structure having a high efficiency solar control system;

FIG. 2 is a cross-sectional view of a window of the building structure shown in FIG. 1;

FIG. 2A is a cross sectional view of a prior art building structure window without an absorption film;

FIG. 2B is a cross sectional view of the prior art building structure window with an absorption film;

FIG. 3 is an enlarged view of the window shown in FIG. 2;

FIG. 4 illustrates an alternate embodiment of the film shown in FIG. 3; and

FIG. 5 illustrates thermal radiation emanating from within a building structure being absorbed by a glass window and being reflected back into an interior of the building structure by a film having an infrared reflecting core.

### DETAILED DESCRIPTION

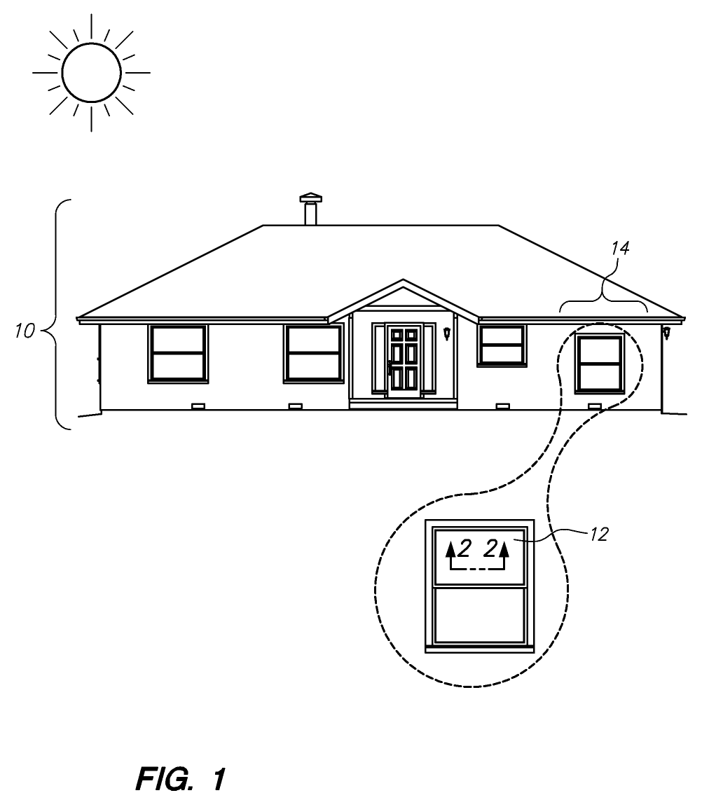

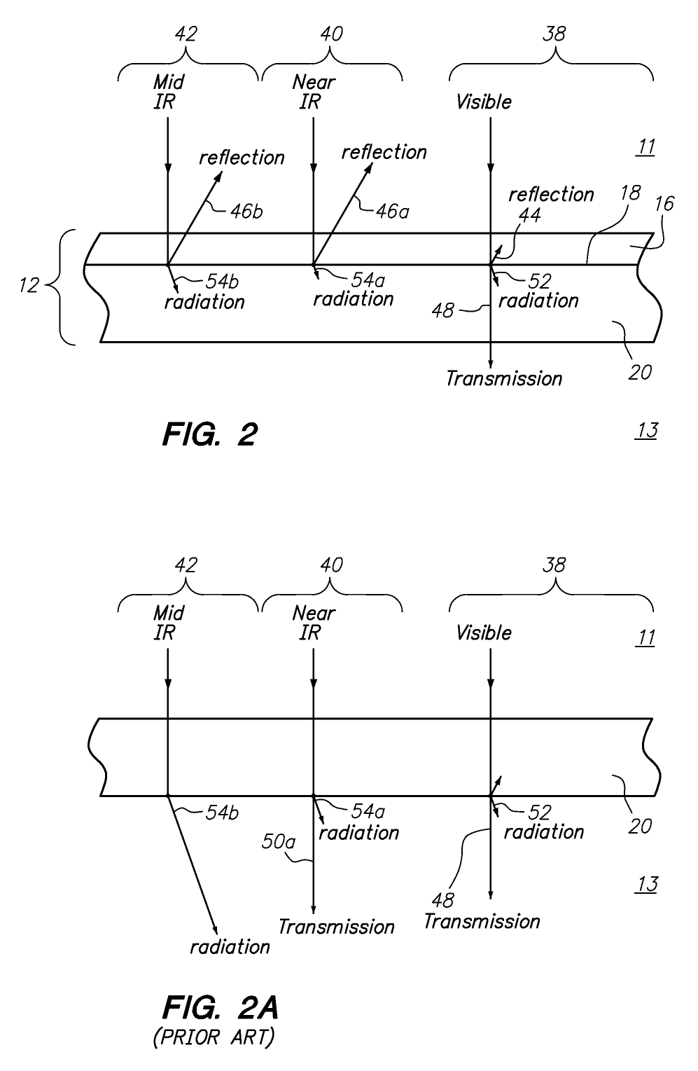

Referring now to FIG. 1, a building structure 10 having a window 12 is shown. The window 12 protects the occupants from environmental elements (e.g., wind, rain, etc.) yet allows the occupants to view the surroundings from within a room 14 of the building structure 10. As shown in FIG. 2, the window 12 may have a film 16 attached to an exterior side 18 of a glass 20. The film 16 may be generally optically transparent in the visible wavelengths and generally reflect radiation in the non-visible or infrared wavelengths. The sun's rays transmit solar radiation both in the visible light range and also in the infrared range. A majority of the radiation in the infrared range may be reflected back to the exterior 11 of the room 14 or the building structure 10 by the film 16. A small portion of the energy may be transmitted into the room 14 through the glass 20 of the window and a small portion is absorbed by the glass 20, converted into heat and re-radiated into the interior 13 of the room 14. Beneficially, the film 16 reduces the amount of solar radiation in the near and mid infrared ranges from entering into the room 14 or the building structure 10 by reflecting a large percentage back to the environment. As such, the amount of solar radiation introduced into the air of the room 14 or building structure 10, absorbed into the interior of the room 14 and contacting the occupant's skin is reduced. This lowers the average air temperature within the room 14 or the building structure 10. This also reduces discomfort of the occupants due to exposure to infrared radiation when the occupant is in the line of sight of the sun. Beneficially, the film 16 increases the occupant's comfort with respect to temperature.

Conversely, during colder months, it is desirable to retain heat within the building structure 10. The objects and occupants within the building structure emanate thermal radiation in all directions including toward the windows. This thermal radiation is reflected by the film 16 back into the building structure.

As will be discussed further herein, the film 16 is mounted to an exterior of the glass 20 of a window 12 of a building structure 10 to reduce solar radiation load during the summer months and retain heat within the building structure 10 during the winter months.

Referring now to FIG. 2, solar radiation may be divided into the visible range 38, near infrared range 40, and the mid-infrared range 42. For each of these ranges 38, 40, 42, a portion of the solar radiation is transmitted through the film 16 and a portion of the solar radiation is reflected back to the exterior 11 of the room 14 or the building structure 10 as shown by arrows 44, 46a, b. In the visible range 38, a large percentage (i.e., more than 50%, but preferably about 70% or more) of the light is transmitted through the film 16. In contrast, in the near infrared range 40 or the mid infrared range 42, a large percentage (i.e., more than 50% but preferably about 80% or more) of the light is reflected back to the exterior 11 of the room 14 or building structure 10. Since the film 16 is mounted to the exterior of the glass 20, less of the near infrared radiation 40 and the mid infrared radiation 42 reaches the glass 20 compared to the prior art as shown by comparing FIG. 2 with FIGS. 2A and 2B. FIG. 2A illustrates untreated glass 20. FIG. 2B illustrates glass 20 with a commonly used absorption film 55 mounted to the interior or inside of the glass 20. In FIG. 2B, the reflected mid infrared radiation may be absorbed by the glass 20. In certain cases, the heat from the absorbed radiation may detrimentally affect (e.g., break) the glass 20. The lengths of the lines 54a, b and 50a which generally indicates magnitude of transmission and radiation is longer in FIGS. 2A and 2B compared to FIG. 2. As shown, the glass 20 is heated to a lesser extent and the amount of near and mid IR radiation 40 transmitted through the glass 20 is less with use of the film 16 mounted to the exterior of the glass 20 such that the heat load on the building structure 10 and occupant exposure to near infrared radiation 40 is reduced. This promotes less or no use of the air conditioning system and/or fan.

For that portion of the solar radiation transmitted through the film 16, a portion is transmitted through the glass 20 in the visible range as shown by arrow 48. The remainder is absorbed into the glass 20 thereby heating the glass 20 and reradiated as thermal radiation into the interior 13 of the room 14 or building structure as shown by arrows 52, 54a, b. Generally for residential glass, all of mid infrared radiation 42 is absorbed by the glass 20 and reradiated into the interior 13 of the room 14 or building structure as shown by arrow 54b. However, it is contemplated that other glass compositions may be employed for building structures such that a portion of the mid infrared radiation 42 may be transmitted through the glass 20. The film 16 has a high percentage (i.e., more than 50% but preferably about 70% or more) of transmission 48 of the solar radiation in the visible range 38 and a high percentage (i.e., more than 50% but preferably 80% or more) of reflection 46a, b in the near-infrared range 40 and the mid-infrared range 42. The film 16 also reflects a portion of the solar radiation in the far infrared range (not shown in FIG. 2).

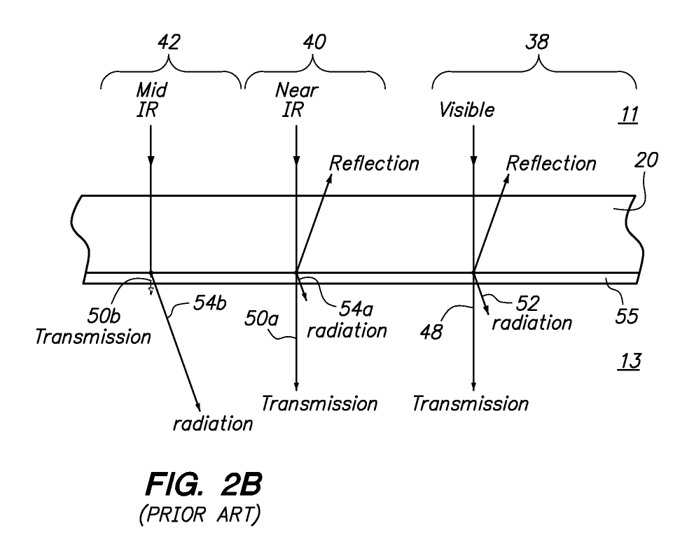

Referring now to FIG. 3, an enlarged cross-sectional view of film 16 and glass 20 is shown. The film 16 may have an infrared reflecting layer 22 with an embedded infrared reflecting core 24. The infrared reflecting core 24 may comprise one or more silver layers 26 and one or more dielectric layers 28. The silver layer 26 and the dielectric layer 28 may alternate such that the infrared reflecting core 24 may comprise a layer of dielectric 28, a layer of silver 26, a layer of dielectric 28, a layer of silver 26, a layer of dielectric 28 all stacked upon each other. Preferably, the dielectric layers 28 are the outermost layers of the embedded infrared reflecting core 24. At a minimum, one silver layer 26 is disposed between two layers of dielectric 28. The silver layers 26 and dielectric layers 28 may have a thickness measured in nanometers. The silver layer 26 may be generally transparent in the visible range and reflect a high percentage of infrared radiation especially in the near infrared range 40 and the mid infrared range 42. The number and thickness of silver layers 26 and the number and thickness of dielectric layers 28 may be adjusted to tune the amount or percentage of infrared radiation being reflected by the infrared reflecting core 24.

The infrared reflecting core 24 may be sandwiched between two layers 30 of material having high transmission (i.e., greater than 50% but preferably about 90% or more) both in the visible range and the near and mid infrared ranges. By way of example and not limitation, the layer 30 may be biaxially-oriented polyethelene terephthalate (hereinafter “BoPET”) mylar. BoPET is the preferred material since it is dimensionally stable (i.e., not elastic), has a high transmission in the visible and near and mid infrared ranges, low scatter and low cost. The dimensional stability of the BoPET layer 30 provides support for the silver layer 26. Otherwise, the silver layer 26 may crack or become damaged upon stretching of the layer 30. Additionally, the infrared reflecting layer 22 is useful for reflecting a high percentage (i.e., more than 50% but preferably about 70% or more) of solar thermal radiation in the near and mid infrared ranges 40, 42 and allowing light in the visible range 38 to be transmitted through the BoPET layers 30 and the infrared reflecting core 24.

One of the characteristics of the silver layer 26 is that upon exposure to oxygen, the silver oxidizes as a black material. In the oxidation process, the silver is converted from a material that reflects heat in the near to mid infrared ranges 40, 42 to a black body that absorbs heat in the near to mid infrared ranges 40, 42. Instead of reflecting a majority of the heat in the near and mid infrared ranges 40, 42, the silver layer 26 now absorbs radiation in both the visible range 38 and the near and mid infrared ranges 40, 42. Detrimentally, the silver layer 26 absorbs and re-radiates such energy into the building structure 10. Additionally, one of the characteristics of the BoPET layer 30 is that oxygen diffuses through the BoPET layer 30 such that oxygen ultimately reaches the silver layer 26 and oxidizes the same 26. To prevent or reduce the rate of oxidation of the silver layers 26 to an acceptable rate, additional layers 30a-d may be stacked on the infrared reflecting layer 22. Any number of layers 30a-n may be stacked on the infrared reflecting layer 22. The amount of oxygen diffused through the layers 30a-n and 30 is a function of a distance 32 from the silver layer 26 and the exterior side 34 of the topmost layer 30. The amount of oxygen reaching the silver layer 26 from an exterior side (i.e., from outside the building structure 10) is reduced since the oxygen must travel a greater distance through the layers 30a-n and 30. On the interior side, the film 16 is mounted to the glass 20 which protects the silver layer(s) 26 from oxidation. Oxygen does not pass through the glass 20.

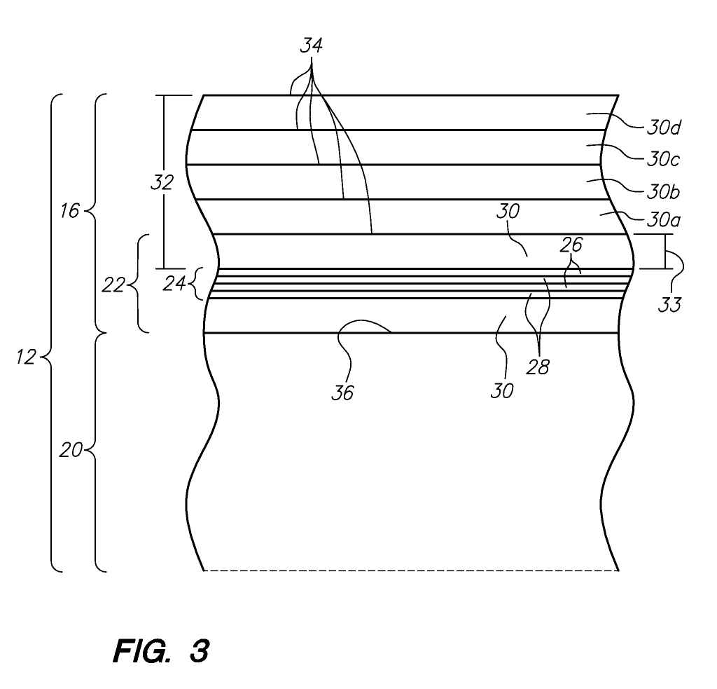

Alternatively, it is contemplated that the thickness 33 of the BoPET layer 30 in the infrared reflecting layer 22 may be increased (see FIG. 4) to slow down the rate of oxidation of the silver layers 26 to an acceptable level. Additionally, an additional stack of BoPET layers 30a-n may be adhered to the BoPET layer 30 on the exterior side, as shown in FIG. 4. The stack of BoPET layers 30a-n may be removably adhered to each other such that the topmost BoPET layer 30a-n may be used as a sacrificial top layer as discussed herein.

Referring back to FIG. 3, during use, the exterior side 34 of the topmost layer 30d is exposed to environmental elements such as rain (containing chemicals), rocks, dirt, ultraviolet light, etc. As such, the exterior side 34 of the topmost layer 30d may experience physical degradation (e.g., chips, oxidation, etc.). It may be difficult to see through the film 16 due to the degradation of the topmost layer 30d. Beneficially, each of the layers 30a-d may be removed (e.g., peeled away) from each other and also from the infrared reflecting layer 22. The then topmost layer behaves as a sacrificial layer which is removed when it has been unacceptably degraded by the environmental elements. To this end, the layer 30d may be peelably adhered to layer 30c, layer 30c may be peelably adhered to layer 30d, layer 30d may be peelably adhered to layer 30a and layer 30a may be peelably adhered to the infrared reflecting layer 22. A tab or other means of removing the topmost layer 30d may be provided such that the topmost layer 30d may be peeled off of the adjacent lower layer 30c when the topmost layer 30d is unacceptably degraded. Upon further use, the new top layer 30c experiences physical degradation. When the then topmost layer 30c is degraded to an unacceptable level, the topmost layer 30c is now peeled away from the top layer 30b. The process is repeated for layers 30b and 30a. As the topmost layers 30d, c, b, a are peeled away, the rate of oxidation of the silver layer 26 increases. As such, the number of layers 30a-n may be increased or decreased based on the required useful life of the film 16. To extend the useful life of the film 16, additional layers 30a-n are stacked upon each other to increase the distance 32. Conversely, to decrease the useful life of the film 16, fewer layers 30a-n are stacked upon each other to decrease the distance 32. When the silver layer 26 is unacceptably oxidized, the entire film 16 is removed from the glass 20 and a new film 16 is mounted to the exterior surface 36 of the glass 20.

Each of the BoPET layers 30a-d and 30 may define an exterior side 34. An ultraviolet light absorbing hard coat may be coated onto the exterior side 34 of the BoPET layers 30a-d and 30 to slow the damaging effects of ultraviolet light on the BoPET layer 30. Additionally, the adhesive for attaching the BoPET layers 30a-d to each other as well as the adhesive for adhering the BoPET layer 30a to the infrared reflecting layer 22 may be an ultraviolet light absorbing adhesive to further slow the damage of ultraviolet light exposure. Such adhesives may continuously cover most if not all of the BoPET layer 30a-d and the infrared reflecting layer 22.

A method for attaching the film 16 to the glass window 20 will now be described. Initially, the film 16 is provided. The film 16 may have a peelable protective layer on both sides to protect the silver layers 26 from oxidation and the exterior surfaces from oxidation as well as chipping prior to installation and during storage. The protective layer may be impermeable to oxygen to prevent oxidation of the exterior surfaces of the film 16 as well as oxidation of the silver layers 26. The protective layer may also block ultraviolet light to mitigate damage to the film 16 in the event the film 16 is left out in the sun. The protective layer may be adhered to the exterior surfaces of the film 16 in a peelable fashion. Prior to mounting the film 16 to the glass 20, the film 16 may be cut to the size of the building structure window. After the film 16 is cut to size, the protective layers may be peeled away to expose the film 16. The exposed side of the infrared reflecting layer 22 may have a pressure sensitive adhesive that may be activated by water or other fluid. The pressure sensitive adhesive may continuously cover most if not all of the exposed side of the infrared reflecting layer 22. The exterior side of the glass 20 may be wetted down with water or the other fluid. The cut film 16 may now be laid over the exterior side of the window 12. Any air bubbles may be squeegeed out. The moist adhesive on the infrared reflecting layer 22 is allowed to dry such that the film 16 is mounted to the glass 20 and the film 16 cannot slip with respect to the glass 20.

The film 16 may be fabricated in the following manner. Initially, a BoPET layer 30 is provided as a roll. The BoPET layer 30 is unrolled and a layer of dielectric 28 is formed on one side of the BoPET layer 30. The thickness of the BoPET layer 30 may be approximately two thousandths of an inch thick. The thickness of the dielectric layer 28 may be measured in nanometers. As the layer of dielectric 28 is laid on one side of the BoPET layer 30, the BoPET layer 30 is rerolled. The BoPET layer 30 is then unrolled such that a layer of silver 26 may then be laid on top of the layer of dielectric 28. The silver layer 26 is also measured in nanometers and is extremely thin. The BoPET layer 30 is rolled back up and unrolled a number of times until the desired number of silver and dielectric layers 26, 28 is attained. A second BoPET layer 30 (about 0.002 inches thick) may be laminated onto the dielectric layer 28 such that two BoPET layers 30 sandwich the alternating layers of silver 26 and dielectric 28 which form the infrared reflecting core 24. Thereafter, additional layers of BoPET 30a-n (each layer being about 0.002 inches thick) may be laminated onto the infrared reflecting layer 22 to serve as a sacrificial layer and reduce the rate of oxygen diffusion. Optionally, protective layers for protecting the film 16 during storage and prior to installation may be laminated onto opposed sides of the film 16. The thickness of the film 16 may be limited by the amount of bending required to roll the film 16 during manufacture. For thicker films 16, it is contemplated that the film 16 may be fabricated in a sheet form process.

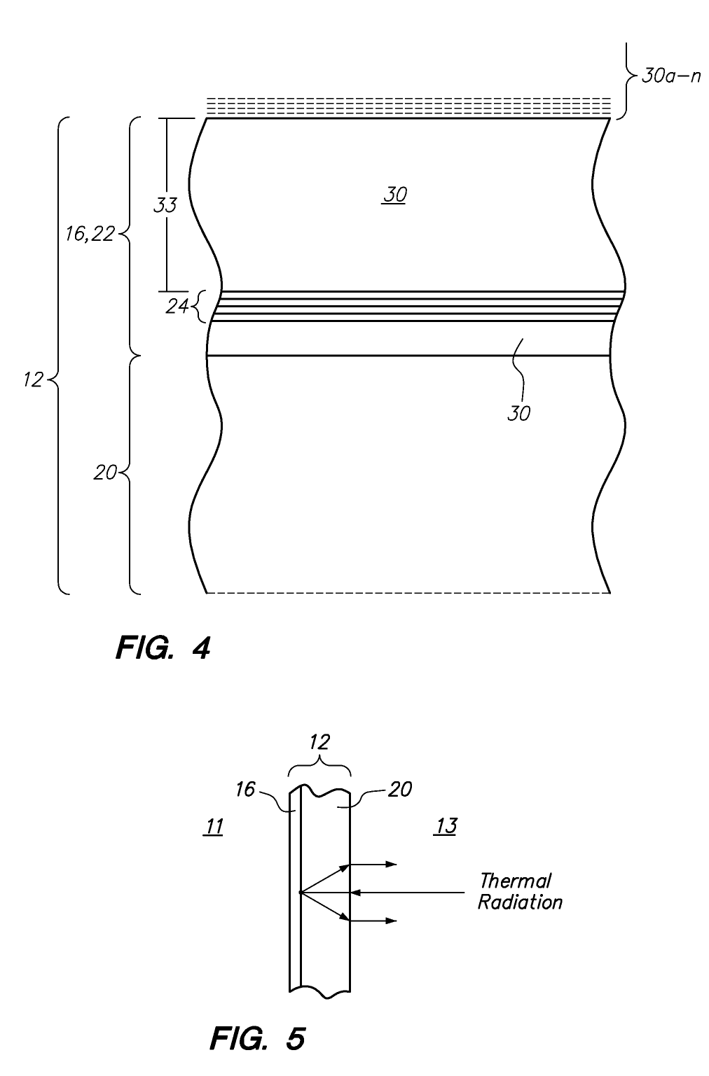

Referring now to FIG. 5, thermal radiation emanates from within the building structure 10. The source of the thermal radiation within the building structure 10 may be the occupant's body heat, a light bulb, stove, heat from objects, etc. Generally, thermal radiation emits infrared radiation in the near, mid and far infrared ranges. A portion of this radiated thermal radiation in the near, mid and far infrared ranges reaches the window 12 of the building structure 10. A portion of the thermal radiation is absorbed by the glass 20 of the window 12. A portion of the thermal radiation is transmitted through the glass 20 and reflected off of the film 16 back toward the interior 13 of the building structure 10. The film 16 may be effective to reflect a majority (i.e., more than 50% preferably 90%) if not all of the mid and far infrared radiation and approximately fifty (50) % of the near infrared radiation. Additionally, the thermal radiation absorbed by the glass 20 heats the glass 20 and emits thermal radiation in the near, mid and far infrared ranges toward the exterior 11 of the building structure 10 as well as the interior 13 of the building structure 10. For that portion of the thermal radiation transmitted toward the exterior 11 of the building structure 10, the film 16 reflects the thermal radiation in the near, mid and far infrared ranges to direct the thermal radiation back into the interior 13 of the building structure 10. As such, the film 16 retains the thermal radiation emanating from objects and people within the building structure 10.

The various aspects of the film 16 discussed herein was described and shown with respect to a single pane glass window 12. However, it is contemplated that the film 16 may be used in conjunction with other types of windows 12 such as single pane windows, windows manufactured from plastic, etc.

The above description is given by way of example, and not limitation. Given the above disclosure, one skilled in the art could devise variations that are within the scope and spirit of the invention disclosed herein, including various ways of adhering the film 16 to the glass 20. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A building structure for protecting people from an environment, the building structure comprising:
a glass window defining an interior side and an exterior side;
a film attached to the exterior side of the glass window for reflecting solar infrared radiation away from the glass window to the environment and reflecting thermal radiation back into the building structure, the film comprising:
an infrared reflecting layer defining an interior side and an exterior side, the interior side of the infrared reflecting layer attached to the exterior side of the glass window, the infrared reflecting layer having an embedded infrared reflecting core which comprises one or more layers of silver and one or more layers of dielectric for reflecting infrared radiation;
one or more protective layers removeably attached to the exterior side of the infrared reflecting layer for mitigating oxidation of the silver layer and for providing a sacrificial top layer which can be removed when damaged due to ultraviolet light exposure or oxidation.

2. The building structure of claim 1 further comprising an adhesive layer disposed between the infrared reflecting layer and the glass window for adhering the film to the glass window.

3. The building structure of claim 1 wherein the infrared reflecting layer is generally transparent to visible spectrum of light.

4. The building structure of claim 1 wherein the infrared reflecting layer is biaxially-oriented polyethelene terephthalate.

5. The building structure of claim 1 wherein the silver and dielectric layers alternate.

6. The building structure of claim 1 wherein the protective layers are peelably adhered to one another.

7. The building structure of claim 1 wherein an exterior side of each of the protective layers has an ultraviolet light absorbing hard coat.

8. The building structure of claim 2 wherein the adhesive is an ultraviolet light absorbing adhesive.

9. The building structure of claim 1 wherein the one or more protective layers is sufficiently thick to reduce the rate of oxidation of the silver layer to a level such that the film has a sufficiently useful long life.

10. The building structure of claim 1 wherein the one or more protective layers is fabricated from biaxially-oriented polyethelene terephthalate.

11. A method for reducing solar radiation load on a building structure or reducing a heating requirement, the method comprising the steps of:
providing a film for reflecting infrared radiation to an exterior of the building structure for reducing the solar radiation load or to an interior of the building structure to retain heat therewithin, the film comprising:
an infrared reflecting layer defining an interior side and an exterior side, the infrared reflecting layer having an embedded infrared reflecting core which comprises one or more layers of silver and one or more layers of dielectric for reflecting infrared radiation; and
one or more protective layers removeably attached to the exterior side of the infrared reflecting layer for mitigating oxidation of the silver layer and for providing a sacrificial top layer which can be removed when damaged due to ultraviolet light exposure or oxidation; and
attaching an interior side of the infrared reflecting layer to an exterior side of a glass window of the building structure.

12. The method of claim 11 wherein the attaching step comprising the step of adhering the interior side of the infrared reflecting layer to the exterior side of the glass window.

13. The method of claim 11 further comprising the steps of providing a stack of sacrificial layers removeably attached to each other such that a top most sacrificial layer may be removed and discarded when the top most protective layer is damaged due to ultraviolet light exposure or oxidation;
and mounting the stack of sacrificial layers to the one or more protective layers.

14. A building structure comprising:
a glass window defining an interior side and an exterior side;
a film attached to the exterior side of the glass window for reflecting infrared radiation away from the glass window, the film comprising:
infrared reflecting core which comprises one or more layers of silver and one or more layers of dielectric for reflecting infrared radiation, the infrared reflecting core defining opposed first and second sides;
a first protective layers attached to the first side of the infrared reflecting layer, the first protective layer having a first thickness;
a second protective layer attached to the second side of the infrared reflecting layer and the glass window, the second protective layer having a second thickness, the first thickness being greater than the second thickness;
wherein the first and second protective layers provide structural support to the one or more silver layers, and the thicker first protective layer mitigates oxidation of the one or more silver layers caused by oxygen diffusion through the first protective layer.

15. The building structure of claim 14 further comprising a stack of sacrificial layers removeably attached to each other such that a top most sacrificial layer may be removed and discarded when the top most sacrificial layer is damaged due to ultraviolet light exposure or oxidation.

16. The building structure of claim 14 wherein the sacrificial layers are adhered to each other.

17. The building structure of claim 12 wherein the first thickness is sufficiently thick to reduce the rate of oxidation of the silver layer to a level such that the film has a sufficiently long useful life.
